(19) United States
(12) Patent Application Publication
(10) Pub. No.: US 2004/0064955 A1
(43) Pub. Date: Apr. 8, 2004

(54) Handles of a puncher

(76) Inventor: Ching Tsung Tsai, Chang Hua (TW)

Correspondence Address: TROXELL LAW OFFICE PLLC, SUITE 1404, 5205 LEESBURG PIKE, FALLS CHURCH, VA, 22041, US

(21) Appl. No.: 10/265,151

(22) Filed: Oct. 7, 2002

(51) Int. Cl. B25G 1/00

(52) U.S. Cl. 30/340

(57) ABSTRACT

The handles of a single hole puncher are respectively fitted around with a soft handle sleeve made of a PU foamed body. The handle sleeves enable a user to hold and squeeze the handles with comfort, able to prevent the handles from slipping off in the process of punching and enhance smoothness and safety in use.

### BACKGROUND OF THE INVENTION

This invention relates to the handles of a single hole puncher, particularly to ones enabling a user to hold and squeeze them with comfort, able to prevent the user's hand from slipping off to ensure safety in use.

A conventional single hole puncher 1, as shown in FIG. 1, is composed of a punching portion 2 and two handles 3, having a torsion spring 4 provided on an inner side between the two handles 3. In using, when the two handles 3 are forcefully squeezed inward, the punching portion 2 by leverage will clamp papers and punch a hole by compression of its punching stud 5 fixed on the upper inner side, so that the papers can be arranged and filed conveniently. After finishing punching and releasing squeezing force, the two handles 3 will recover their original positions by the recovering resilience of the torsion spring 4.

However, the conventional single hole puncher 1 is made of metal and its two handles 3 are forcefully held and squeezed by the force applied by a user's fingers and the joints between a thumb and an index finger. Under such circumstances, after a long term of operating or repeated squeezing the two handles 3, the joints of a user's hand is likely to incur aching and inflammation. Besides the conventional single hole puncher 1 has its surface electroplated with a metallic outer layer to increase its smoothness, therefore the puncher 1 is most likely to slip off in the process of punching if a user's hand is sweaty. Further, after a long term of use, the electroplated outer layer of the two handles 3 eroded by salty sweat of a user's hand may peel off and produce rusty spots which mat stab and hurt the hand of a user.

### SUMMARY OF THE INVENTION

One objective of this invention is to offer the handles of a single hole puncher, respectively fitted around with a soft handle sleeve to let a user hold them with comfort during punching, able to prevent slipping off and elevate smoothness and security in use.

Another objective of this invention is to offer the handles of a single hole puncher, respectively covered up by a handle sleeve to avoid a user's hand directly touching the surface of the metallic handle and prevent salty sweat of the user's hand from eroding the surfaces of the two handles.

### BRIEF DESCRIPTION OF DRAWINGS

This invention will be better understood by referring to the accompanying drawings, wherein:

FIG. 1 is a side view of a conventional single hole puncher:

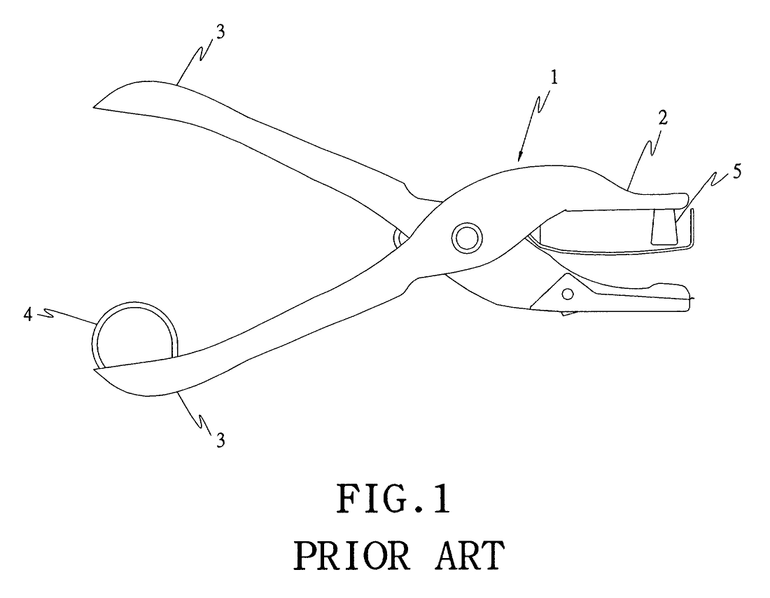

FIG. 2 is a side view of a first embodiment of a single hole puncher in the present invention:

FIG. 3 is perspective view of the first embodiment of the handle sleeve in the present invention:

FIG. 4 is a partial cross-sectional view of the first embodiment of the single hole puncher in the present invention: and

FIG. 5 is a perspective view of a second embodiment of a handle sleeve in the present invention.

### DETAILED DESCRIPTION OF THE PREFERRED EMBODIMENT

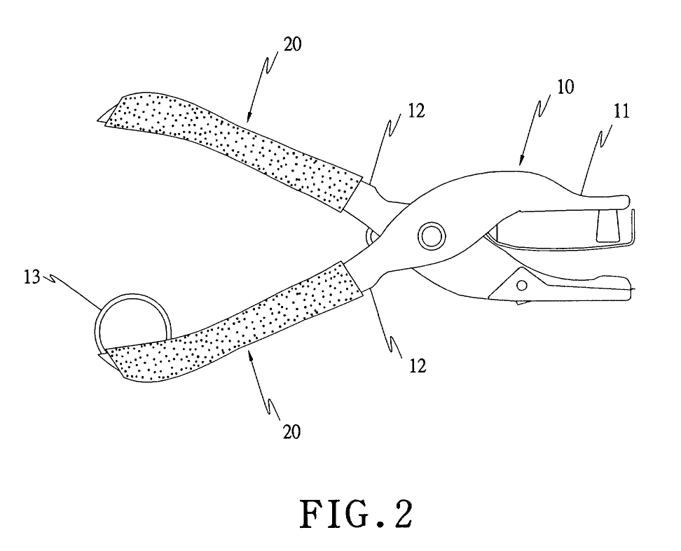

A first preferred embodiment of a single hole puncher in the present invention, as shown in FIG. 2, includes a punching portion 11, two handles 12, a torsion spring 13 and two handle sleeves 20 combined together.

The punching portion 11, the two handles 12 and the torsion spring 13 are the same as those of the conventional puncher mentioned above, so they are no longer described herein.

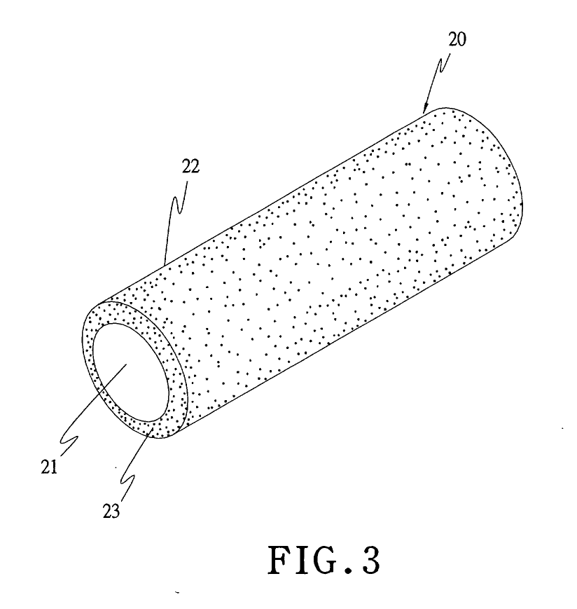

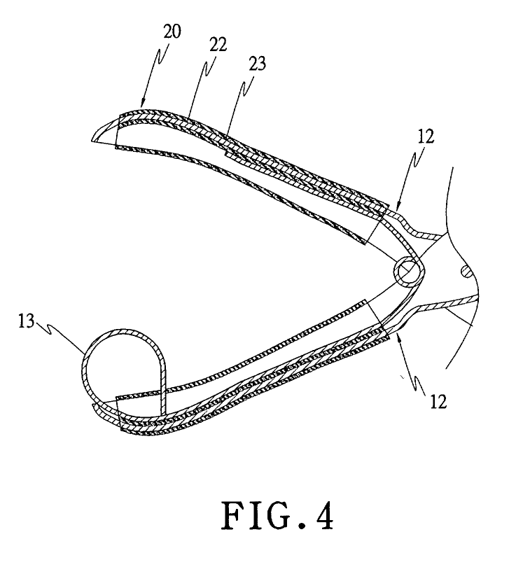

The handle sleeve 20, as shown in FIGS. 3 and 4, is a cylinder-shaped PU foamed body having an axial through hole 21 in the center to be fitted around the handle 12. The handle sleeve 20 has a preset thickness and contractile resilience, so that when the handle sleeve 20 is fitted around the handle 12, its can be tightly contact the surface of the handle 12. Further, the handle sleeve 20 has its outer circumference formed into a rough surface 22 with a small foam density so as to offer a contact surface of good frictional effect for a user to hold them with comfort and avoid slipping off. The through hole 21 has its inner wall formed into a slip-preventive surface 23 with a large foam density, so that it can stably contact the surface of the handle 12.

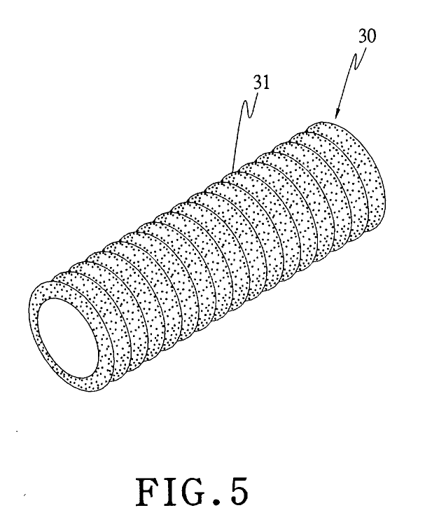

A second preferred embodiment of a handle sleeve in the present invention, as shown in FIG. 5, is to have the outer circumferential surface of the handle sleeve 30 formed with regularly corrugated grains 31 to offer excellent feeling of touch in holding and beautify the appearance of a puncher as well.

In assembling, as shown in FIGS. 3 and 4, simply expand a little the through hole 21 of the handle sleeve 20 and fit it around the end of the handle 12 and then push the handle sleeve 20 upward to cover up the handle 12. Besides, the handle sleeve 20 is contractile so it can entirely and closely contact to the surface of the handle 12 tightly after it is fitted around the handle 12, able to match with the shape of the handle 12 and keep integration of appearance of a handle 12.

As can be noted from the above description, this invention has some advantages described below.

1. The handle sleeve 20 has excellent flexibility and a changeable shape, so it cannot only enable a user to hold it with comfort but also protect the hand joints of the user from wrenching.

2. The handle sleeve 20 has its outer circumference formed into the rough surface 22, so it enables a user to hold it firmly to avoid slipping off and ensure safety.

3. The handle sleeve separates a user's hand from the handle 12, so the salty sweat of a user's hand can be blocked and sucked by the handle sleeve 20, able to protect the surface of the handle 12 from rusting and peeling off, and prolong its service life.

4. The handle sleeve 20 is shaped by foaming, so it can be designed with different colors to be fitted around the handle 12 to beautify the appearance of a single hole puncher. Besides, the handle sleeve 20 can easily be replaced with a new one after used for a period of time.

While the preferred embodiments of the invention have been described above, it will be recognized and understood that various modifications may be made therein and the appended claims are intended to cover all such modifications that may fall within the spirit and scope of the invention.

I Claim

1. A single hole puncher comprising a punching portion, two handles and a torsion spring, said torsion spring positioned between inner sides of said two handles: and,
Characterized by said two handles respectively fitted around with a handle sleeve, said handle sleeve being a foamed body, said handle sleeve formed with an axial through hole in the center, said axial through hole fitted around said handle, said handle sleeve having a preset thickness and contractile resilience, said contractile resilience enabling said handle sleeve to closely contact the surface of said handle stably when said handle sleeve covers up said handle.

2. The handles of a single hole puncher as claimed in claim 1, wherein said handle sleeve has its outer circumference formed into a rough surface with a small foam density, and the inner wall of said through hole formed into a slip-preventive surface with a large foam density so as to enable said handle sleeve to closely contact the surface of said handle stably when fitted around said handle.

3. The handles of a single hole puncher as claimed in claims 1 and 2, wherein said handle sleeve has its outer surface formed into regularly corrugated grains.

4. The handles of a single hole puncher as claimed in claim 1 , wherein said handle sleeve is a PU foamed body.

5. The handles of a single hole puncher as claimed in claim 1, wherein said handle sleeve is designed to have predetermined colors.
